(19) United States
(12) Patent Application Publication
(10) Pub. No.: US 2006/0098629 A1
(43) Pub. Date: May 11, 2006

(54) Data transmitter, data transmission method, data receiver, and data reception processing method

(75) Inventor: Isao Watanabe, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/265,243

(22) Filed: Nov. 3, 2005

(30) Foreign Application Priority Data
Nov. 5, 2004 (JP) 2004-322479

(51) Int. Cl. H04L 12/66

(52) U.S. Cl. 370/352

(57) ABSTRACT

A data receiver according to an embodiment of this invention includes a reception unit configured to receive time-limited video data for which a storage time limit is set, and voice data corresponding to this time-limited video data, a storage unit configured to store the time-limited video data and the voice data received by the reception unit, an output unit configured to output the time-limited video data and the voice data stored in the storage unit, and a data processing unit configured to process the time-limited video data on the basis of the storage time limit set for the time-limited video data stored in the storage unit.

### CROSS-REFERENCE TO RELATED APPLICATIONS

This application is based upon and claims the benefit of priority from prior Japanese Patent Application No. 2004-322479, filed Nov. 5, 2004, the entire contents of which are incorporated herein by reference.

### BACKGROUND OF THE INVENTION

1. Field of the Invention

The present invention relates to a data transmitter for transmitting video and voice data of a video phone (fixed phone or mobile phone) or the like. Also, the present invention relates to a data transmission method in such data transmitter. The present invention relates to a data receiver for receiving video and voice data of a video phone (fixed phone or mobile phone) or the like. Furthermore, the present invention relates to a data reception processing method in such data receiver.

2. Description of the Related Art

In recent years, various proposals about video phones have been made. For example, Japanese Pat. Appln. KOKAI Publication No. 8-317357 discloses a technique for recording only a partial picture (moving or still picture) required to recognize a partner together with a voice message upon recording a video message. With this technique, the data size to be saved in a memory of a video phone can be reduced.

Also, various proposals about voice message systems have been made. For example, Japanese Pat. Appln. KOKAI Publication No. 11-98249 discloses a technique for storing a voice message, and erasing that voice message after an elapse of a given storage period of this voice message.

A message recording function of a video phone records a message including voice and video data of a message sender. Such message including voice and video data can transmit information with sense of reality. At the same time, there is a demand to limit use of the video data of the message sender.

The aforementioned prior art cannot limit use of the video data of the message including voice and video data.

### BRIEF SUMMARY OF THE INVENTION

A data transmitter according to an aspect of the present invention comprises: a setting unit configured to set a storage time limit of video data; and a transmission unit configured to transmit the time-limited video data for which the storage time limit is set, and voice data corresponding to the time-limited video data.

A data transmission method according to an aspect of the present invention comprises: setting a storage time limit of video data; and transmitting the time-limited video data for which the storage time limit is set, and voice data corresponding to the time-limited video data.

A data receiver according to an aspect of the present invention comprises: a reception unit configured to receive time-limited video data for which a storage time limit is set, and voice data corresponding to this time-limited video data; a storage unit configured to store the time-limited video data and the voice data received by the reception unit; an output unit configured to output the time-limited video data and the voice data stored in the storage unit; and a data processing unit configured to process the time-limited video data on the basis of the storage time limit set for the time-limited video data stored in the storage unit.

A data reception processing method according to an aspect of the present invention comprises: receiving time-limited video data for which a storage time limit is set, and voice data corresponding to this time-limited video data; storing the received time-limited video data and voice data; processing the time-limited video data on the basis of the storage time limit set for the stored time-limited video data; and outputting the stored time-limited video data and voice data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is a schematic block diagram showing the arrangement of a video phone terminal (data transmitter/receiver) according to an embodiment of the present invention;

FIG. 2 is a flowchart for explaining an example of message transmission processing for transmitting a message from a first video phone terminal to a second video phone terminal;

FIG. 3 is a flowchart for explaining the first example of message reception/management processing for receiving and managing a message (a message including video and voice data) transmitted from the first video phone terminal by the second video phone terminal; and

FIG. 4 is a flowchart for explaining the second example of message reception/management processing for receiving and managing a message (a message including video and voice data) transmitted from the first video phone terminal by the second video phone terminal.

### DETAILED DESCRIPTION OF THE INVENTION

Preferred embodiments of the present invention will now be described with reference to the accompanying drawings.

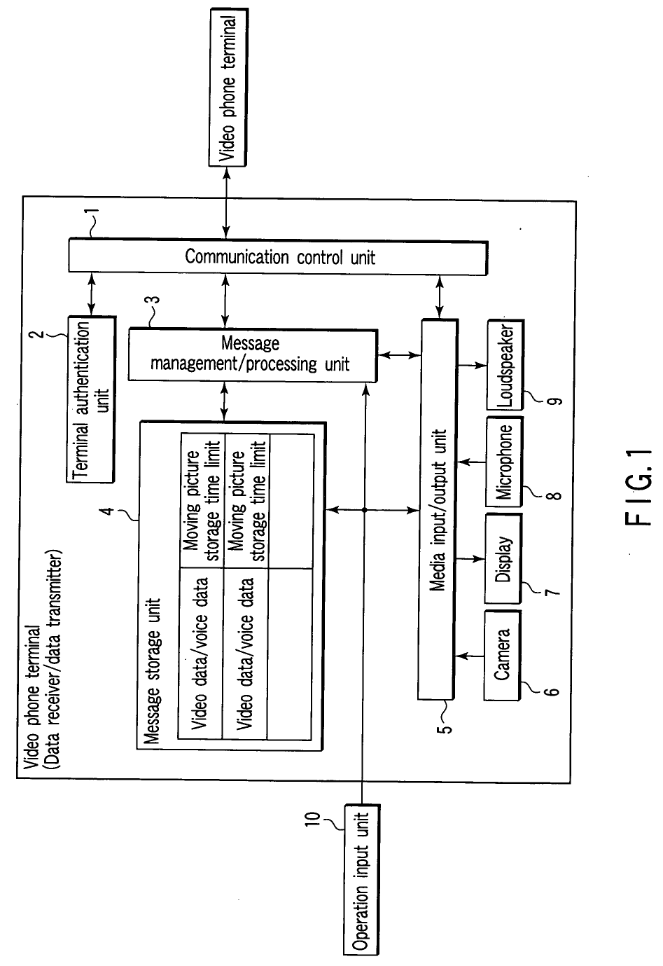

FIG. 1 is a schematic block diagram showing the arrangement of a video phone terminal (data transmitter/receiver) according to an embodiment of the present invention. An example of the video phone terminal corresponds to a mobile or fixed phone. As shown in FIG. 1, the video phone terminal comprises a communication control unit 1, terminal authentication unit 2, message management/processing unit 3, message storage unit 4, media input/output unit 5, camera 6, display 7, microphone 8, loudspeaker 9, and operation input unit 10.

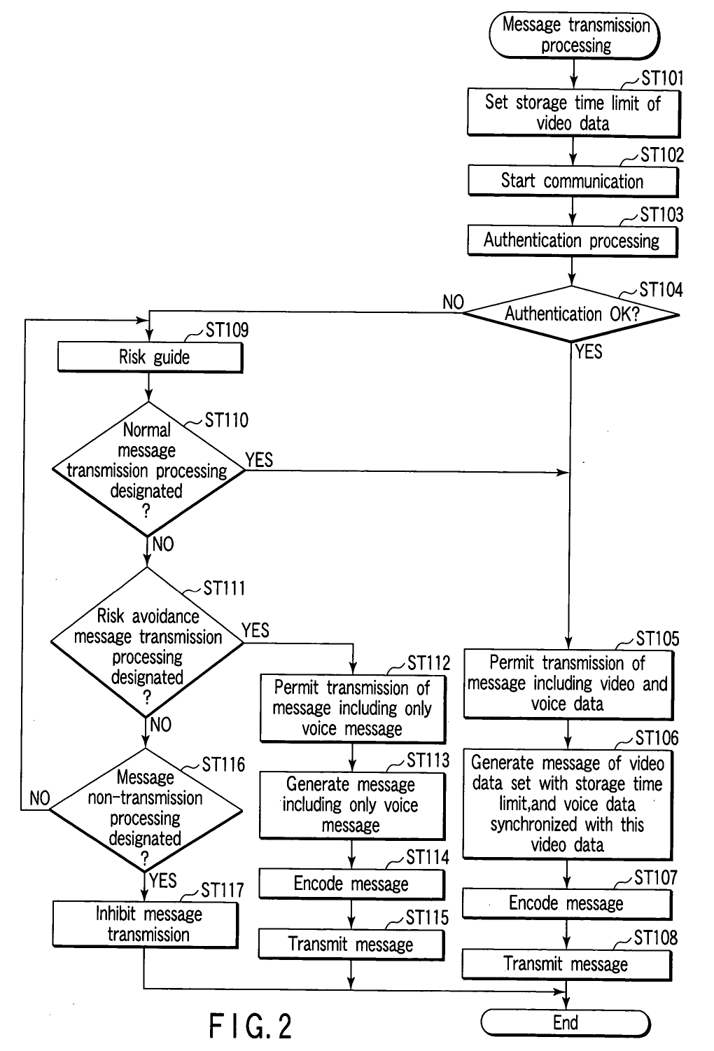

Message transmission processing for transmitting a message from a first video phone terminal to a second video phone terminal will be described below with reference to the flowchart shown in FIG. 2. Transmission of a message including video data (moving picture data) and voice data corresponding to (synchronized with) this video data will be mainly explained below.

In preparation for transmission of a message, the user sets a storage time limit of video data included in a message via the operation input unit 10 of the first video phone terminal (ST101). Of course, when the user uses a default setting, he or she need not particularly set the storage time limit. The set storage or default storage time limit is managed by the message management/processing unit 3. Note that this video phone terminal can receive absolute time information (current time) provided from, e.g., a base station, via the communication control unit 1. The default storage time limit is set based on this absolute time information.

Upon starting a communication between the first and second video phone terminals (ST102), the terminal authentication unit 2 of the first video phone terminal executes authentication processing for a partner terminal (second video phone terminal) (ST103). With this authentication processing, it is determined if the partner terminal (second video phone terminal) can execute appropriate message management.

If the partner terminal cannot be authenticated (ST104, NO), i.e., if it is unknown if the partner terminal can execute appropriate message management, for example, the display 7 displays a warning indicating that there is a risk of inappropriate management of a message transmitted to the partner terminal (ST109). If the user designates normal message transmission processing via the operation input unit 10 (ST110, YES), the message management/processing unit 3 permits transmission of a message including video data and voice data synchronized with this video data (ST105). If the user designates risk avoidance message transmission processing via the operation input unit 10 (ST111, YES), the message management/processing unit 3 permits transmission of a message that does not include any video data, i.e., a message including only voice data (ST112). If the user designates message non-transmission processing via the operation input unit 10 (ST116, YES), the message management/processing unit 3 inhibits transmission of any message (ST117).

On the other hand, if the partner terminal can be authenticated (ST104, YES), i.e., if it is determined that the partner terminal can execute appropriate message management, the message management/processing unit 3 permits transmission of a message including video data and voice data synchronized with this video data (ST105).

If the message management/processing unit 3 permits transmission of a message including video data and voice data synchronized with this video data (ST105), it sets the storage time limit to video data captured by the camera 6, multiplexes (combines) the video data set with the storage time limit and voice data picked up by the microphone 8, and generates a message including the video data and the voice data corresponding to (synchronized with) this video data (ST106). Furthermore, the message management/processing unit 3 encodes the generated message (ST107), and transmits the encoded message to the partner terminal (second video phone terminal) (ST108).

If the message management/processing unit 3 permits transmission of a message including only voice data (ST112), it generates a message including only voice data picked up by the microphone 8 (ST113). Furthermore, the message management/processing unit 3 encodes the generated message (ST114), and transmits the encoded message to the partner terminal (second video phone terminal) (ST115).

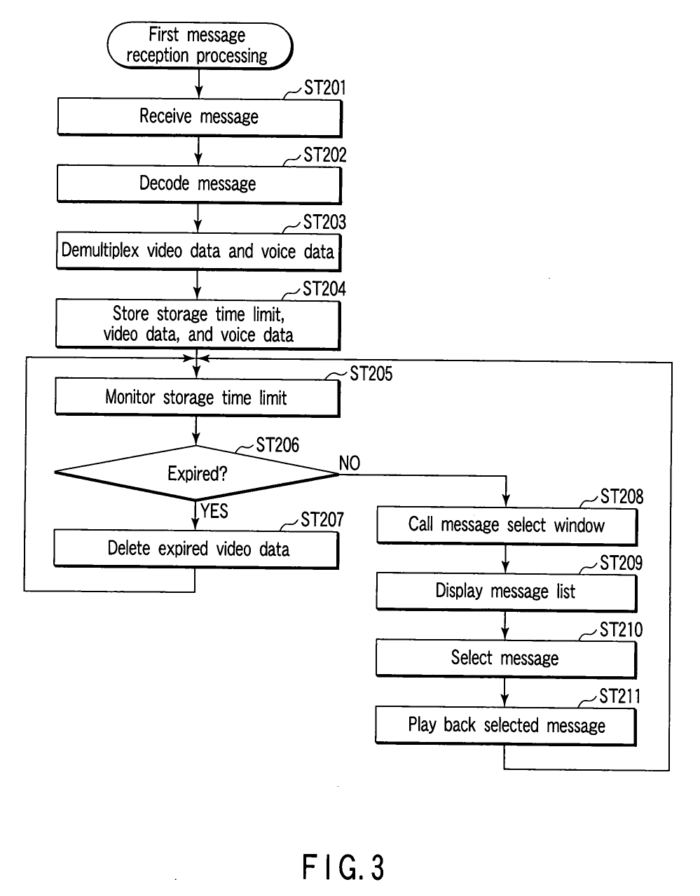

The first example of message reception/management processing for receiving and managing a message (a message including video and voice data) transmitted from the first video phone terminal by the second video phone terminal will be described below with reference to the flowchart shown in FIG. 3.

The communication control unit 1 of the second video phone terminal receives the encoded message (the message including video and voice data) transmitted from the first video phone terminal (ST201). The message management/processing unit 3 of the second video phone terminal decodes the received message (ST202), demultiplexes the message into video and voice data (ST203), and stores them in the message storage unit 4. That is, the message storage unit 4 stores the video data, the storage time limit set for the video data, and the voice data (ST204).

After that, the message management/processing unit 3 monitors the storage time limit set for the video data with reference to the absolute time information transmitted from the base station (ST205), and deletes the expired video data (ST206, YES) (ST207).

If the user calls a message select window via the operation input unit 10 (ST208, YES), the display 7 displays a list of representative pictures of respective messages stored in the message storage unit 4 (ST209). Since there is no representative picture for a message corresponding to video data which is deleted since its storage time limit has expired, a voice message icon indicating a message including only voice data is displayed in place of the representative picture. If the user selects a desired representative picture or voice message icon via the operation input unit 10 (ST210), a message corresponding to this representative picture (a message including both video and voice data) or a message corresponding to the voice message icon (a message including only voice data) is played back (ST211).

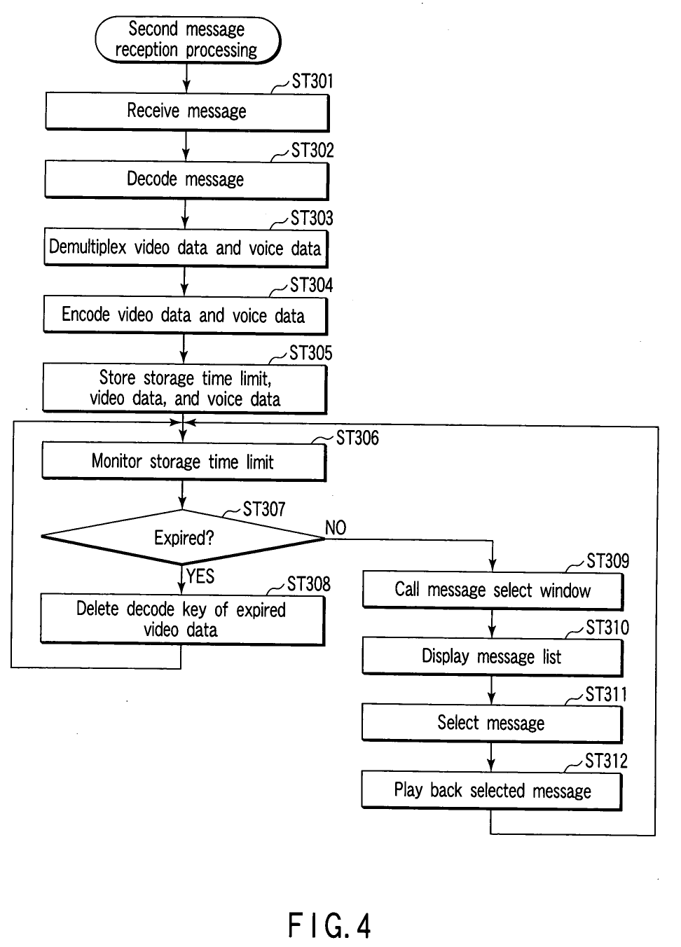

The second example of message reception/management processing for receiving and managing a message (a message including video and voice data) transmitted from the first video phone terminal by the second video phone terminal will be described below with reference to the flowchart shown in FIG. 4.

The communication control unit 1 of the second video phone terminal receives the encoded message (the message including video and voice data) transmitted from the first video phone terminal (ST301). The message management/processing unit 3 of the second video phone terminal decodes the received message (ST302), and demultiplexes the message into video and voice data (ST303). The message management/processing unit 3 encodes the video data, and generates a decode key of this encoded video data. Likewise, the message management/processing unit 3 encodes the voice data, and generates a decode key of this encoded voice data (ST304). Then, the message management/processing unit 3 stores these encoded video and voice data and the decode keys used to decode these encoded video and voice data in the message storage unit 4. That is, the message storage unit 4 stores the encoded video data, the storage time limit set for the video data, and the encoded voice data, and also stores the decode keys for the encoded video and voice data (ST305).

After that, the message management/processing unit 3 monitors the storage time limit set for the video data with reference to the absolute time information transmitted from the base station (ST306), and deletes the decode key of the expired video data (ST307, YES) (ST308).

If the user calls a message select window via the operation input unit 10 (ST309, YES), the display 7 displays a list of items (display items such as reception dates and the like) corresponding to respective messages stored in the message storage unit 4 (ST310). If the user selects a desired item via the operation input unit 10 (ST311), a message corresponding to this item is decoded (ST312) and is played back (ST313). If the decode key of the video data is not deleted, both the video and voice data can be decoded. Hence, the message including both the video and voice data is played back. However, if the decode key of the video data is deleted, since this video data cannot be decoded, voice data alone is decoded and played back.

In the second example of message reception/management processing, a case has been explained wherein video and voice data are separately encoded, and the decode key of the video data is deleted (that of the voice data is not deleted) upon expiration of the storage time limit of the video data. However, the present invention is not limited to such specific case. For example, video and voice data may be encoded together, and decode keys of both the video and voice data may be deleted upon expiration of the storage time limit of the video data. In this case, the voice data can no longer be played back as well. Alternatively, only video data may be encoded, and a decode key of the video data may be deleted upon expiration of the storage time limit of the video data. In this case, since voice data is not encoded, it can be played back intact. Alternatively, access to video data may be inhibited upon expiration of the storage time limit of the video data.

Since the message management/processing unit 3 manages the storage time limit of video data on the basis of the absolute time information, it inhibits playback of the video data if it cannot receive the absolute time information from the base station.

In the above description, a case has been exemplified wherein the transmitting side (first video phone terminal) sets the storage time limit. For example, when the transmitting side does not set any storage time limit, the receiving side (second video phone terminal) may automatically set a predetermined storage time limit.

When the storage capacity of the message storage unit 4 becomes short, the message management/processing unit 3 preferentially deletes video data the storage time limit of which is expired soon, i.e., video data set with the storage time limit closest to the current time. In this way, a storage area can be assured while leaving voice data.

As described above, according to the present invention, since video data is deleted at a predetermined timing (at an expiration timing of the storage time limit), and voice data corresponding to this video data is saved without being deleted, a requirement (voice data) of a message sender can be transmitted without being considerably impaired, while protecting private information (video data) of the message sender. Only management information of video data (address information of the image data storage location) is often deleted in practice even when video data is to be deleted. However, according to the present invention, since the decode key required to decode encoded video data is deleted, the private information (video data) of the message sender can be securely protected. Also, according to the present invention, when the storage capacity becomes short, video data the storage time limit of which is expired soon is deleted. Hence, the short storage capacity problem can be solved, and a requirement (voice data) of the message sender can be transmitted without being considerably impaired. Furthermore, according to the present invention, since a message is transmitted after it is confirmed if the partner terminal can execute appropriate message management, misuse of the private information (video data) of the message sender can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transmitter comprising:
a setting unit configured to set a storage time limit of video data; and
a transmission unit configured to transmit the time-limited video data for which the storage time limit is set, and voice data corresponding to the time-limited video data.

2. A transmitter according to claim 1, further comprising:
an authentication unit configured to authenticate a transmission partner; and
a transmission control unit configured to permit transmission of the time-limited video data and the voice data to the transmission partner authenticated by the authentication unit.

3. A transmitter according to claim 1, further comprising:
an authentication unit configured to authenticate if a transmission partner can perform an operation corresponding to the storage time limit set by the setting unit;
a multiplexing unit configured to multiplex the time-limited video data and the audio data;
an encode unit configured to encode the multiplexed data multiplexed by the multiplexing unit; and
a transmission control unit configured to permit transmission of encoded data encoded by the encode unit to the transmission partner authenticated by the authentication unit.

4. A data transmission method comprising:
setting a storage time limit of video data; and
transmitting the time-limited video data for which the storage time limit is set, and voice data corresponding to the time-limited video data.

5. A data receiver comprising:
a reception unit configured to receive time-limited video data for which a storage time limit is set, and voice data corresponding to this time-limited video data;
a storage unit configured to store the time-limited video data and the voice data received by the reception unit;
an output unit configured to output the time-limited video data and the voice data stored in the storage unit; and
a data processing unit configured to process the time-limited video data on the basis of the storage time limit set for the time-limited video data stored in the storage unit.

6. A receiver according to claim 5, wherein the data processing unit deletes the time-limited video data whose storage time limit has expired.

7. A receiver according to claim 5, wherein the time-limited video data and the voice data received by the reception unit are encoded data obtained by encoding multiplexed data obtained by multiplexing the time-limited video data and the voice data,
the data receiver further comprises:
a decoder configured to decode the encoded data; and
a demultiplexing unit configured to demultiplex the multiplexed data decoded by the decode unit into the time-limited video data and the voice data, and
the data processing unit deletes the time-limited video data whose storage time limit has expired, which is demultiplexed by the demultiplexing unit and is stored in the storage unit.

8. A receiver according to claim 5, wherein the time-limited video data and the voice data received by the reception unit are encoded data obtained by encoding multiplexed data obtained by multiplexing the time-limited video data and the voice data,
the data receiver further comprises:
a first decode unit configured to decode the encoded data;
a demultiplexing unit configured to demultiplex the multiplexed data decoded by the first decode unit into the time-limited video data and the voice data;
an encode unit configured to encode the time-limited video data demultiplexed by the demultiplexing unit, and to generate a decode key of the encoded time-limited video data; and
a second decode unit configured to decode, using the decode key, the time-limited video data which is encoded by the encode unit and is stored in the storage unit, and
the data processing unit deletes the decode key required to decode the time-limited video data a storage time limit of which has expired and which is stored in the storage unit.

9. A receiver according to claim 5, wherein the time-limited video data and the voice data received by the reception unit are encoded data obtained by encoding multiplexed data obtained by multiplexing the time-limited video data and the voice data,
the data receiver further comprises:
a first decode unit configured to decode the encoded data;
a demultiplexing unit configured to demultiplex the multiplexed data decoded by the first decode unit into the time-limited video data and the voice data;
an encode unit configured to encode the time-limited video data demultiplexed by the demultiplexing unit, to generate a first decode key for the encoded time-limited video data, to encode the voice data, and to generate a second decode key for the encoded voice data; and
a second decode unit configured to decode the time-limited video data, which is encoded by the encode unit and is stored in the storage unit, using the first decode key, and to decode the voice data, which is encoded by the encode unit and is stored in the storage unit, using the second decode key, and
the data processing unit deletes the first decode key required to decode the time-limited video data a storage time limit of which has expired and which is stored in the storage unit.

10. A data reception processing method comprising:
receiving time-limited video data for which a storage time limit is set, and voice data corresponding to this time-limited video data;
storing the received time-limited video data and voice data;
processing the time-limited video data on the basis of the storage time limit set for the stored time-limited video data; and
outputting the stored time-limited video data and voice data.
